(19) United States
(12) Patent Application Publication
(10) Pub. No.: US 2002/0143507 A1
(43) Pub. Date: Oct. 3, 2002

(54) 3-D kinematics and tolerance variation analysis

(76) Inventors: Hwei-Min Lu, Zeeland, MI (US); Mahesh Kamatala, Holland, MI (US); Robert Gardner, Holland, MI (US); Debajit Guha, Holland, MI (US); Erik Salisbury, Holland, MI (US); Robin Tao, Canton, MA (US)

Correspondence Address: JENKENS & GILCHRIST, Suite 3200, 1445 Ross Avenue, Dallas, TX, 75202-2799, US

(21) Appl. No.: 09/917,396

(22) Filed: Jul. 26, 2001

Related U.S. Application Data
(60) Provisional application No. 60/220,897, filed on Jul. 26, 2000.

(51) Int. Cl. G06G 7/48

(52) U.S. Cl. 703/7

(57) ABSTRACT

A system and method for providing graphical and analytical dynamic modeling of a multi-dimensional mechanical mechanism. The system includes at dynamic simulation of movement of the multi-dimensional mechanical mechanism, and rendering the multi-dimensional mechanical mechanism. The dynamic simulation simultaneously performs kinematic and tolerance modeling. The system further includes a display for displaying the rendered multi-dimensional mechanical mechanism during the dynamic simulation.

### CROSS REFERENCE TO RELATED APPLICATIONS

This application is related to co-pending U.S. Provisional Application for Patent Serial No. 60/220,897, entitled: SIGMUND 3D-KINEMATICS MODULE ALGORITHM, and filed Jul. 26, 2000, which is hereby incorporated by reference as though set forth in full herein.

### TECHNICAL FIELD OF THE INVENTION

The principles of the present invention generally relate to a kinematic modeling system, and more specifically, but not by way of limitation, to a dynamic modeling system including kinematic modeling having tolerances.

### BACKGROUND OF THE PRESENT INVENTION

Different approaches for kinematics analysis have been used in different mechanical design applications. Approaches for modeling an open-loop system are much simpler and more straight forward than modeling a closed-loop system. In modeling an open-loop system, generally, there is no need to solve non-linear system simultaneous equations in such a system. For a closed-loop system, however, solving non-linear system simultaneous equations is required, and, thus, an efficient and robust algorithm becomes important. One popular approach for modeling a closed-loop system is using a vector loop approach, which requires forming at least one closed-loop in a mechanical system. However, the vector loop approach cannot be applied without knowing whether an open-loop or closed-loop system exists.

In performing the vector loop approach, kinematic governing equations are obtained by forming the proper number of closed-loops in a mechanical system. In general, a vector equation (which is equivalent to three scale equations) is obtained for each closed-loop under consideration. Determining the number of closed-loops and which loop is required for obtaining solutions depends on the configuration of the mechanical system, i.e., how joints/drivers are arranged in a loop. However, if a mechanism becomes complicated, the kinematic governing equations will typically become difficult to obtain. Thus, using the vector loop approach is not particularly efficient or robust. Furthermore, when integrating the vector loop approach with variation analysis, the solution will be, undoubtably, difficult to converge (especially with large variations) because, generally, there are no means available to control potential axis misalignments in the mechanisms due to variations. One typical example of a mechanism is a planar 4-bar linkage. It has one degree of freedom in a plane, but has zero degree of freedom in space. Consequently, if variations cause the linkages to lie on different planes, the solution will almost never converge to a reasonable accuracy. For this reason, the current available vector loop approach, adopted in kinematics analysis with variation analysis packages, cannot actually solve the kinematic governing equations with variation conditions. Alternatively, it is a common to practice to estimate possible results based on kinematics constraints. Therefore, adopting another approach is required to solve the kinematic governing equations with variation conditions.

On the other hand, in performing the Euler parameters approach, the governing equations are obtained by equating joint constraints directly through a coordinate transformation using a set of nonlinear equations expressed by general coordinates of two connected parts. Adopting Euler parameters in a transformation matrix simplifies the kinematic governing equations, and also takes into account the flexibility of a piece part. Because the kinematic governing equations are obtained by equating the joint constraints directly through the coordinate transformation, potential misalignments in the mechanisms due to variations can be easily controlled. Moreover, because there is generally no need to form any closed-loops, the Euler parameters approach can thus be applied in both open-loop and closed-loop systems without having to know the type of the system. Additionally, the kinematic governing equations obtained are independent of the configuration of the mechanical system, i.e., how joints/drivers are arranged in the system. Therefore, even though a mechanism becomes very complicated (i.e., having multiple loops and/or multiple joints in apiece part and/or multiple piece parts connected to a joint), the kinematic governing equations can still be easily obtained. Thus, it can be said that the Euler parameters approach is efficient and robust, and also proper for being integrated with variation analysis packages.

Presently, conventional modeling systems generate kinematic models of a dynamic mechanical system and apply random tolerance parameters at different steps along a trajectory to determine the results of the modeled mechanical system. By applying random tolerance parameters at different steps, the piece parts are changed throughout the trajectory and a user is unable to interactively view and/or obtain results for a single mechanical system.

### SUMMARY OF THE INVENTION

To overcome the problems of conventional modeling techniques, integration of kinematic and tolerance modeling is performed to allow interactive viewing and/or obtaining results of a dynamic mechanical system. One embodiment of the present invention includes a system and method for providing graphical and analytical dynamic modeling of a multi-dimensional mechanical mechanism. The system includes at least one processor for computing dynamic simulation of movement of the multi-dimensional mechanical mechanism, and rendering the multi-dimensional mechanical mechanism. The dynamic simulation simultaneously performs kinematic and tolerance modeling. The system further includes a display for displaying the rendered multi-dimensional mechanical mechanism during the dynamic simulation.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is an exemplary system block diagram for performing the principles of the present invention;

FIG. 2 is an exemplary flow diagram describing operations of a multi-dimensional kinematic and dynamic modeling simulation having tolerance variations according to the principles of the present invention executed by the system of FIG. 1;

FIGS. 3a and 3b (collectively FIG. 3) is a detailed flow diagram for performing the operations according to FIG. 2; and

FIG. 4 is an exemplary graphical user interface (GUI) for building, displaying, and simulating a multi-dimensional kinematic model according to FIG. 3.

### DETAILED DESCRIPTION OF THE DRAWINGS

The principles of the present invention will now be described more fully hereinafter with reference to the accompanying drawings, in which exemplary embodiments of the present invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Multi-dimensional kinematic and dynamic modeling is an important aspect to mechanical engineering design and development projects. Kinematic and dynamic modeling provides a design engineer invaluable information for designing a robust mechanism. By modeling a mechanism and performing a dynamic simulation, the design engineer may determine structural weaknesses, accuracy of specification, and tolerance robustness, for example. A dynamic modeling system that provides results for the design engineer to comprehensively determine performance of the mechanism may include a process for simultaneously simulating kinematic and tolerance variation analysis. The simulation may include using a Monte Carlo random variable technique in varying either or both of the kinematics and tolerances.

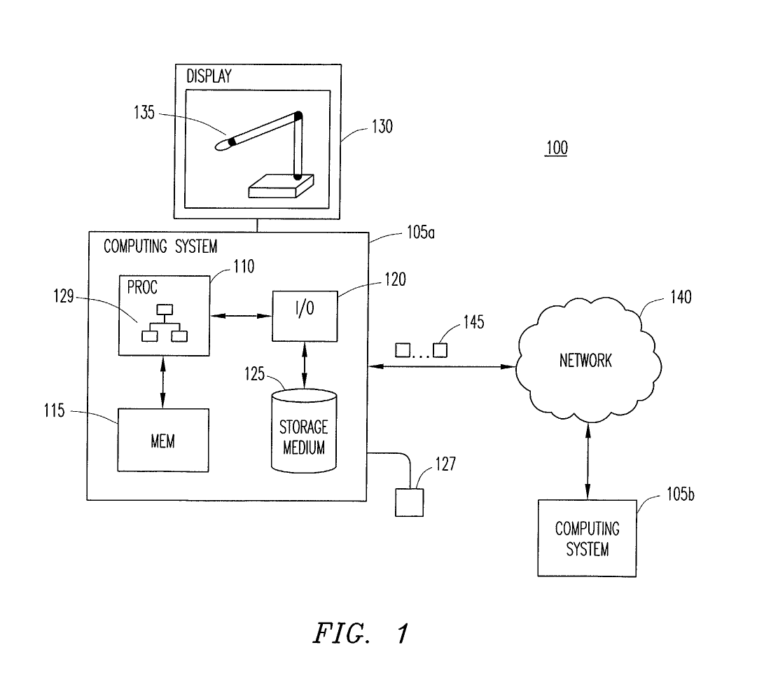

FIG. 1 is an exemplary system block diagram 100 for performing the principles of the present invention. A computing system 105 a includes a processor 110 coupled to a memory 115. The processor 110 is further coupled to an input/output (I/O) device 120, which may further be coupled to a storage medium 125. The processor 110 may be a single processor or multiple processors operating in parallel. A control device 127, such as a computer mouse, keyboard, and/or touch pad, may be coupled to the computing system 105 a for controlling a software program 129 operating on the processor 110. A display 130 is connected to the I/O device 120 in the computing system 105 a for displaying information generated by the processor.

In operation, according to the principles of the present invention, the computing system 105a is utilized to generate and display a kinematic model of a mechanical component 135. To generate the kinematic model of the mechanical component 135, the processor 110 executes the software program 129 stored in the memory 115 as loaded from the storage medium 125. A user of the computing system 105a controls the execution of the software program 129 by using the control device 127. The kinematic model of the mechanical component 135 may be generated by selecting and grouping, via the control device 127, piece parts as rendered on the display 130. The model may define orientation and interaction of the mechanical component 135. Alternatively, the mechanical component 135 may be generated by other means as known in the art, such as using a keyboard and alphanumeric expressions (e.g., a software program).

The computing system 105a maybe coupled to a network 140 whereby data packets 145 may be communicated across the network 140 to a remote computing system 105b. The network 140 may be a local area network (LAN), wide area network (WAN), or the Internet, for example. The computing system 105a may be a server for executing the software program 129 as accessed and controlled by the remote computing system 105b.

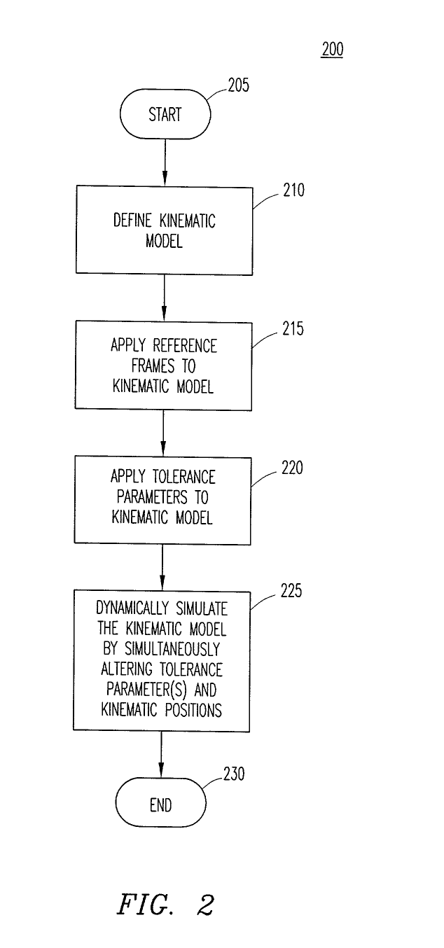

FIG. 2 is an exemplary flow diagram describing operations of a multi-dimensional kinematic and dynamic modeling simulation according to the principles of the present invention executed by the system 100 of FIG. 1. The process starts at step 205. At step 210, a kinematic model is defined to form a mechanical mechanism (e. g., automobile engine valve). In defining the kinematic model, piece part components may be arranged or connected using predefined software tools, such as graphical or programming tools. For example, a graphical user interface (GUI) may have predefined piece part tools for rods, gears, hinges, etc., and the piece parts maybe coupled in a graphical manner.

At step 215, reference frames (e.g., multi-dimensional coordinate systems) may be applied to the kinematic model. The reference frames generally include an origin or base frame that operates as an absolute reference and reference frames at joints to operated as relative references. Similar to the defining of the kinematic model at step 210, graphical or programming tools may be used to apply the reference frames to the kinematic model. The reference frames are generally applied at connection points (i.e., joints) of the piece parts that are used to form the kinematic model. By defining the reference frames, a simulator may be utilized to operate the kinematic model having a knowledge of the relative and absolute positions of the piece parts.

At step 220, tolerance parameters are applied to the kinematic model. The tolerance parameters generally take the form of+/−X, where X is a decimal number. A technique known in the art as geometric dimensioning and tolerancing (GD&T) is a generic type of generating tolerance parameters and may be used to form the tolerances. The tolerance parameters may be aligned with the reference frames located at the joints of the piece parts. Alternatively, the tolerance parameters may be defined with different reference frames having different origins than the reference frames. The order of applying the tolerances (e.g., tolerance parameters before frames or frames before tolerances) does not affect results of the simulation. It should be understood that the tolerance parameters generally have the same number of multi-dimensions as the kinematic model, so that if the kinematic model is three-dimensional, the tolerance parameters are defined in three dimensions.

At step 225, the kinematic model including the tolerance parameters may be dynamically and simultaneously simulated. In performing the simulation, a Monte Carlo random model simulation technique may be employed. The Monte Carlo simulation technique generally applies a random or pseudo-random function to a selected variable. For example, the simulation may select one tolerance parameter, in one or more dimension, to apply a pseudo-random function having a Gaussian or other distribution.

During the simulation, the simulation drives the kinematic model in a predetermined movement (e.g., engine valve moving up and down) while also applying the pseudo-random function to the tolerance parameter. The simulation may drive the kinematic model through the same movement while applying the pseudo-random function to different tolerance parameters on an individual basis. Alternatively, multiple tolerance parameters may be applied a pseudo-random distribution during the simulation. It should be understood that other variations of the simulation may be employed to produce different statistical effects. However, by performing a dynamic simulation that simultaneously varies both the kinematic model and the tolerance parameters, a design engineer may view and obtain important information of the mechanical mechanism that is not possible by dynamically varying the kinematic model and tolerance parameters separately (i.e., serially). The process ends at step 230.

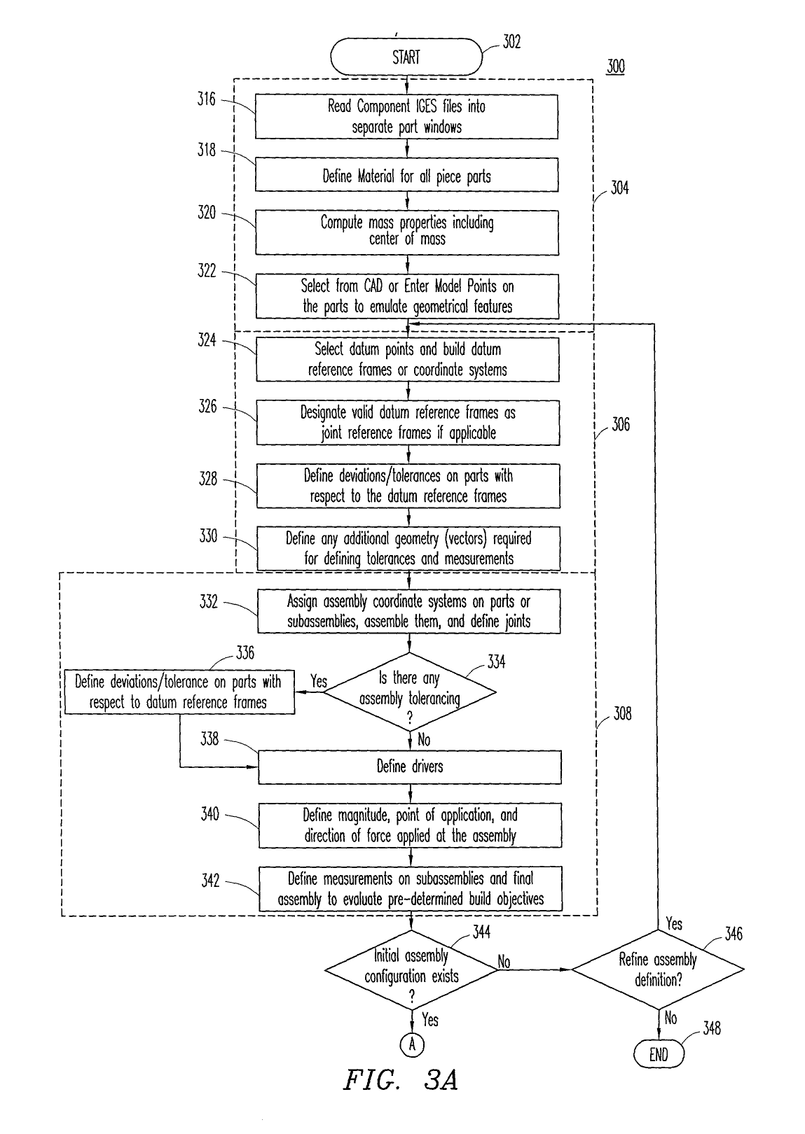

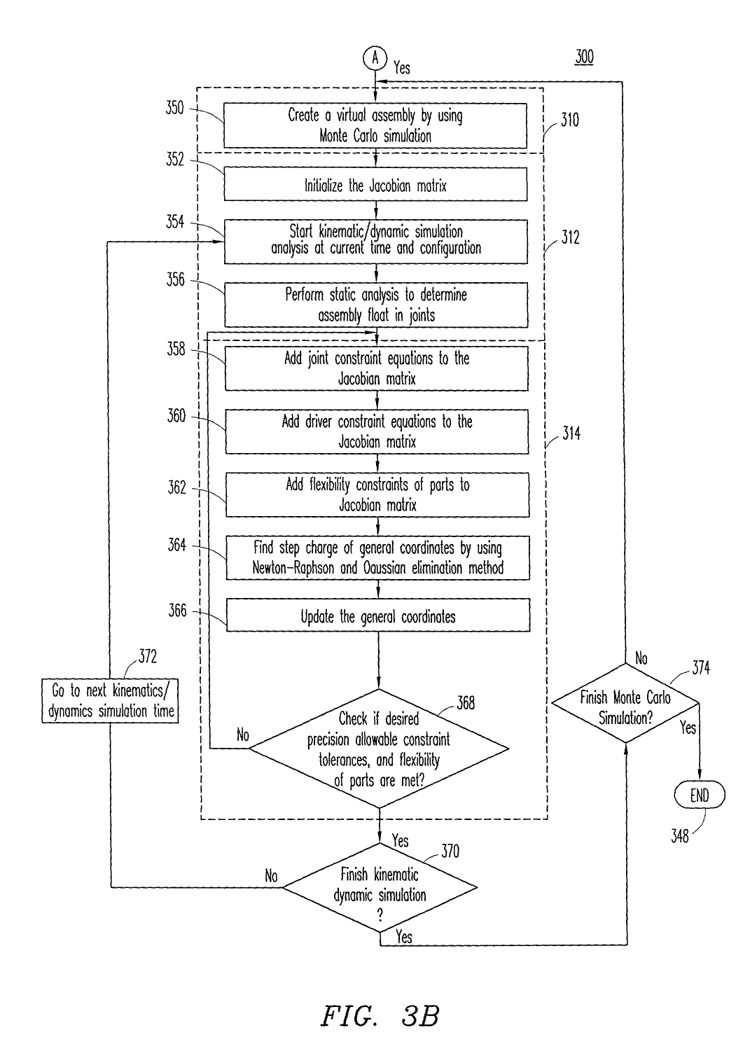

FIGS. 3a and 3b (collectively FIG. 3) is a detailed flow diagram 300 for performing the operations according to FIG. 2. The process starts at step 302. A number of general steps are shown in dashed boxes. At step 304, individual piece parts may be received as designed by a design engineer using a computer aided design (CAD) software program. Alternatively, the principles of the present invention may be incorporated into a CAD system. At step 306, reference frames, including joint reference frames, coordinate systems, and datum reference frames, maybe applied to the mechanical mechanism may be applied by selecting datum points on the piece parts. Additionally, tolerance parameters may be applied to the mechanical mechanism by applying the tolerance parameters to the piece parts. Using the reference frames, the piece parts may be assembled into a final mechanism at step 308. At step 310, a mechanical mechanism is created from the piece parts.

As understood in the art, the number of joint constraints for each joint depends on the joint type. For example, a weld joint has six joint constraints. Revolution, roller, cam or prismatic joints have five joint constraints. Cylindrical or universal joints has four joint constraints. Spherical or planar joints have three joint constraints. Finally, a bearing joint has two joint constraints.

At step 312, the simulation is initialized and commenced. The initialization may include initializing a Jacobian matrix (Jx) based on the number of joint constraints, drivers, and piece parts involved. Drivers represent a power source that determines the motion of the mechanism and are added to joint axes to set the mechanism in motion in a specific way. At step 314, the Monte Carlo simulation is executed. The simulation may include performing a Monte Carlo simulation for individual or multiple tolerance variables simultaneously while performing a dynamic movement of the kinematic model for the mechanical mechanism. The simulation may end upon fault condition being met, the final position has been reached, or the simulation duration pre-specified has ended.

Specifically, the methodology of the present invention is shown with regard to the particular steps shown in solid blocks. In general step 304, the component information is read into separate part windows at step 316 from the CAD software. The component information may be imported in the form of International Graphics Exchange Syntax (IGES) files into a operating GUI. At step 318, materials for all piece parts may be defined to determine the properties of parts from a database that store the piece part data. At step 320, mass properties including center of mass may be computed. For each component in the assembly, the mass properties computed are mass, volume, surface area, and moment of inertia, and center of mass, for example. At step 322, geometrical features for emulation are selected from CAD or part model points. Specifically, the geometrical features on the piece part may be emulated by either picking vertices on CAD data, by entering the coordinates of the model points, or by selecting features in the CAD data.

In general step 306, reference frames or coordinate systems are then constructed from the selected datum points at step 324, and valid datum reference frames designated as joint reference frames by selecting the model points created in step 322, if applicable, at step 326. Where appropriate, datum reference frames created in step 324 may also be used as joint reference frames.

At step 328, deviations and tolerances on respective parts are then defined along with additional geometry, e.g., vectors, needed to define tolerances and measurements at step 330. To simulate variation of a feature, additional geometry required, such as a line, vector, or axis is also created at step 330. Further, to define a measurement, additional geometry required, such as a line, vector, or axis may also be created at step 330. In general step 308, assembly coordinate systems are then assigned on the parts or subassemblies at step 332. The datum reference frames or coordinate systems defined in step 322 may be designated as assembly coordinate systems in the parts or subassemblies. The datum reference frames or coordinate systems may also be used to designate the joint type between the parts/sub-assemblies resulting in an assembly.

At step 334, a determination may be made whether any assembly tolerances are to be applied. If yes (i.e., assembly tolerances are to be applied), then deviations or tolerance on components are defined with respect to datum reference frames or coordinate systems at step 336; otherwise, where applicable, drivers are defined at step 338. At step 340, magnitude, point or area of application, and direction of force applied at the assembly may be defined. At step 342, measurements on subassemblies and final assembly are defined to evaluate pre-determined build objectives.

At step 344, a determination is made whether an initial assembly configuration exists, i.e., whether the initial assembly configuration is possible based upon the information given. If not, then a further determination is made as to whether the assembly definition requires refinement at step 346. If not, then the simulation ends at step 348; otherwise control reverts back to step 324 for further datum and reference frame selection.

In general step 310, if the assembly configuration exists, then a virtual assembly is generated, e.g., using a Monte Carlo simulation at step 350. The virtual assembly may not satisfy all joint constraints for a closed-loop system due to variations. The general coordinates of the parts in the assembly may then be used for an initial trial (i.e., x⁽⁰⁾) for kinematics analysis. Details regarding the general coordinates are discussed after discussion of FIG. 3B. At step 352, a Jacobian matrix defining relative positions of the piece parts is initialized. The size of the Jacobian matrix is initialized based on the number of joint constraints, drivers, and piece parts involved. Again, the number of joint constraints in each joint depends on its type.

In general step 312, the kinematic and dynamic simulation analysis starts at step 354 having a given time (driver positions) for the assembly configuration generated by the Monte Carlo simulation. For a new assembly configuration, time (driver positions) are reinitialized. At step 356, static analyses are performed to determine the assembly float in the joints. Results depend on the direction of reaction in the joints.

In general step 314, requisite joint constraints are added to the Jacobian matrix at step 358: For each joint,joint constraints maybe associated with proper elements of the Jacobian matrix J(x) and position vector F(x) based on the joint type and its associated parts. It should be noted that the column of the Jacobian matrix where the joint constraints to be applied depends on its connected parts. At step 360, driver constraints are added to the Jacobian matrix:. For each driver, driver constraints are placed to proper elements of the Jacobian matrix J(x) and position vector F(x) based on the driver type and its associated parts. It should be noted that the column of the Jacobian matrix where the driver constraints to be applied depends on its related parts.

At step 362, flexibility constraints of parts are added to the Jacobian matrix. For each part (except ground), flexibility constraints are placed to proper elements of the Jacobian matrix J(x) and position vector F(x). It should be noted that the column of the Jacobian matrix where the flexibility constraints to be applied also depends on the part itself. At step 364, step changes for the general coordinates are computed, for example, using Newton-Raphson and Gaussian elimination methods. The step changes of general coordinates Dx^{(k)} are computed by solving a set of linear equations (A6), presented below, using Gaussian elimination and backward substitution with total pivoting. The advantage of total pivoting allows for taking singularity into account, such as multiple solutions.

At step 366, after updating the general coordinates using equation (A7), a determination is made at step 368 as to whether the desired precision, allowable constraint tolerances, and flexibility of piece parts are met. For example, the step changes of general coordinates Dx^{(k)} are checked to determine whether desired precision is met. Also, at step 368, the constraint equations are checked to determine whether allowable tolerances and conditions of the flexibility of piece parts are satisfied.

If any condition is not met, control reverts back to step 358 for re-evaluating the Jacobian matrix J(x) and position vector F(x) using the updated general coordinates (i.e., performed Newton-Raphson's iterations). However, if allowable iterations are reached and the conditions are still not met, it means that no solutions exist for the current assembly configuration and driver positions. And, general coordinates of piece parts are restored to the previous convergent solution. Otherwise, if all conditions described above are met at step 368, a further determination is made at step 370 as to whether the kinematic/dynamic simulation is to be finished.

If it is determined at step 370 that the simulation is not to be finished, then the time step is advanced, and the kinematics and dynamics simulation analysis is repeated for the current assembly configuration at step 372 and control reverts back to step 354; otherwise, a further determination is made at step 374 as to whether the Monte Carol simulation is finished. If not, control reverts back to step 350; otherwise, the simulation ends at step 348.

According to Newton-Raphson's Method for nonlinear systems, a given set of nonlinear equations may be defined:

$$\begin{matrix}{f}_{1} ( {x}_{1} , {x}_{2} , … , {x}_{n} ) = 0 \\ {f}_{2} ( {x}_{1} , {x}_{2} , … , {x}_{n} ) = 0 \\ ⋮ \\ ⋮ \\ {f}_{n} ( {x}_{1} , {x}_{2} , … , {x}_{n} ) = 0\end{matrix} \qquad ( A1 )$$

The solution may be converged by the iteration procedure evolved from initial solution x⁽⁰⁾ as follows:

x^{(k)}=x^{(k-1)}−J(x^{(k-1)})⁻¹F(x^{(k-1)}) (A2)

Where k≧1 and the matrix J(x) is called Jacobian matrix, defined as:

$$J ( x ) = [ \begin{matrix}\frac{\partial {f}_{1} ( x )}{\partial {x}_{1}} & \frac{\partial {f}_{1} ( x )}{\partial {x}_{2}} & … & \frac{\partial {f}_{1} ( x )}{\partial {x}_{n}} \\ \frac{\partial {f}_{2} ( x )}{\partial {x}_{1}} & \frac{\partial {f}_{2} ( x )}{\partial {x}_{2}} & … & \frac{\partial {f}_{2} ( x )}{\partial {x}_{n}} \\ ⋮ & ⋮ & & ⋮ \\ \frac{\partial {f}_{n} ( x )}{\partial {x}_{1}} & \frac{\partial {f}_{n} ( x )}{\partial {x}_{2}} & ⋮ & \frac{\partial {f}_{n} ( x )}{\partial {x}_{n}}\end{matrix} ] \qquad ( A3 )$$

Vectors x and F(x) are defined as follows:

$$x = [ \begin{matrix}{x}_{1} \\ {x}_{2} \\ ⋮ \\ {x}_{n}\end{matrix} ] , F ( x ) = [ \begin{matrix}{f}_{1} ( x ) \\ {f}_{2} ( x ) \\ ⋮ \\ {f}_{n} ( x )\end{matrix} ] \qquad ( A4 , A5 )$$

Therefore, a set of nonlinear equations will be reduced to solve a sequential of linear system equations.

J(x^{(k-1)})Δx^{(k)}=−F(x^{(k-1)}) (A6)

Where

Δx^{(k)}=x^{(k)}−x^{(k-1)} (A7)

Gaussian elimination and backward substitution with maximal or total pivoting is then applied.

Gaussian elimination and backward substitution may be performed by the following procedure:

Given a set of linear equations

$${E}_{1} : {a}_{11} {x}_{1} + {a}_{12} {x}_{2} + … + {a}_{1 n} {x}_{n} = {b}_{1} \\ {E}_{2} : {a}_{21} {x}_{1} + {a}_{22} {x}_{2} + … + {a}_{2 n} {x}_{n} = {b}_{2} \\ ⋮ ⋮ ⋮ ⋮ ⋮ \\ {E}_{n} : {a}_{n1} {x}_{1} + {a}_{n2} {x}_{2} + … + {a}_{n n} {x}_{n} = {b}_{n} \qquad ( B1 )$$

An augmented matrix Ã n then formed:

$$\tilde{A} = [ \begin{matrix}A & b ]\end{matrix} = [ \begin{matrix}{a}_{11} & {a}_{12} & … & {a}_{1 n} & {a}_{1 , n + 1} \\ {a}_{21} & {a}_{22} & … & {a}_{2 n} & {a}_{2 , n + 1} \\ ⋮ & ⋮ & & ⋮ & ⋮ \\ {a}_{n1} & {a}_{n2} & … & {a}_{n n} & {a}_{n , n + 1}\end{matrix} ] \qquad ( B2 )$$

Where Ã denotes the matrix formed by the coefficients and the entries in the (n+1)-th column are the values of b that is a_{1,n+1}=b₁ for each i=1, 2, . . . , n. Provided that a₁₁≠0, the operations corresponding to (Eⱼ−(aⱼ₁/a₁₁)E₁)→(Eⱼ) are performed for each j=2, 3, . . . , n to eliminate the coefficient of x₁ in each of these rows. Follow a sequential procedure for i=2, 3, . . . , n−1 and perform the operation (Eⱼ−(aⱼ₁/a₁₁)E₁)→(Eⱼ) for each j=i+1, i+2, . . . , n, provided that a₁₁=0. This eliminates the coefficient of x₁ in Eⱼ for all values of i=1, 2, . . . , j−1(2≦j≦n). The resulting augmented matrix has the form:

$$\tilde{\overline{A}} = [ \begin{matrix}{\overline{a}}_{11} & {\overline{a}}_{12} & … & {\overline{a}}_{1 n} & {\overline{a}}_{1 , n + 1} \\ 0 & {\overline{a}}_{22} & … & {\overline{a}}_{2 n} & {\overline{a}}_{2 , n + 1} \\ ⋮ & ⋰ & ⋰ & ⋮ & ⋮ \\ 0 & … & 0 & {\overline{a}}_{n n} & {\overline{a}}_{n , n + 1}\end{matrix} ] \qquad ( B3 )$$

Where, except in the first row, the values of \overline{a}_{y} are not expected to agree with those in the original matrix Ã. This matrix represents a linear system with the same solution set as system (B1). Since the equivalent linear system is triangular:

$${\overline{E}}_{1} : {\overline{a}}_{11} {x}_{1} + {\overline{a}}_{12} {x}_{2} + … + {\overline{a}}_{1 n} {x}_{n} = {\overline{a}}_{1 , n + 1} \\ {\overline{E}}_{2} : {\overline{a}}_{22} {x}_{2} + … + {\overline{a}}_{2 n} {x}_{n} = {\overline{a}}_{2 , n + 1} \\ ⋰ ⋮ ⋮ \\ {\overline{E}}_{n} : {\overline{a}}_{n n} {x}_{n} = {\overline{a}}_{n , n + 1} \qquad ( B4 )$$

Backward substitution can be performed. Solving the n-th equation for xₙ gives

$${x}_{n} = \frac{{\overline{a}}_{n , n + 1}}{{\overline{a}}_{n n}} \qquad ( B5 )$$

Solving the (n−1)-th equation for xₙ₋₁ and using xₙ yields

$${x}_{n - 1} = \frac{{\overline{a}}_{n - 1 , n + 1} - {\overline{a}}_{n - 1 , n} {x}_{n}}{{\overline{a}}_{n - 1 , n - 1}} \qquad ( B6 )$$

And continuing this process, all variables can be obtained by

$$\begin{matrix}{x}_{i} = \frac{{\overline{a}}_{i , n + 1} - {\overline{a}}_{i n} {x}_{n} - {\overline{a}}_{i , n - 1} {x}_{n - 1} - … - {\overline{a}}_{i , i + 1} {x}_{i + 1}}{{\overline{a}}_{i i}} \\ = \frac{{\overline{a}}_{i , n + 1} - {\sum }_{j = i + 1}^{n} {\overline{a}}_{ij} {x}_{j}}{{\overline{a}}_{i i}} for each i = n - 1 , n - 2 , … , 2 , 1\end{matrix} \qquad ( B7 )$$

However, the procedure will not work if one of diagonal elements \overline{a}ᵢᵢ is zero during elimination procedure. Therefore, pivoting strategies are required.

Maximal (or total) pivoting may be performed by using the following procedure. Maximal pivoting at the k-th step searches all the entries aᵢⱼ, for i=k, k+1, . . . , n, and j=k, k+1, . . . , n to find the entry with the largest magnitude. Both row and column interchanges are performed to bring this entry to the pivot position.

In further discussion of the Euler parameters approach (as utilized in step 366), general coordinates are used for relative position of any piece part with respect to a global coordinate system of the whole assembly (or ground—non-moving part) is represented by transformation matrix as follows:

$$[ \begin{matrix}2 ( {e}_{1}^{2} + {e}_{2}^{2} - 0.5 ) & 2 ( {e}_{2} {e}_{3} - {e}_{1} {e}_{4} ) & 2 ( {e}_{2} {e}_{4} + {e}_{1} {e}_{3} ) & {t}_{x} \\ 2 ( {e}_{2} {e}_{3} + {e}_{1} {e}_{4} ) & 2 ( {e}_{1}^{2} + {e}_{3}^{2} - 0.5 ) & 2 ( {e}_{3} {e}_{4} - {e}_{1} {e}_{2} ) & {t}_{y} \\ 2 ( {e}_{2} {e}_{4} - {e}_{1} {e}_{3} ) & 2 ( {e}_{3} {e}_{4} + {e}_{1} {e}_{2} ) & 2 ( {e}_{1}^{2} + {e}_{4}^{2} - 0.5 ) & {t}_{z} \\ 0 & 0 & 0 & 1\end{matrix} ] \qquad ( C1 )$$

Where rotation matrix are composed of e₁, e₂, e₃, e₄ called Euler parameters and tₓ, t_{y}, t_{z}. are translation components. These seven variables are denoted as general coordinates of the piece part. Here, an additional variable is introduced in rotation matrix. If the part is a rigid body, additional constraint, e₁²+e₂²+e₃²+e₄²=1, is applied.

For a given joint, joint constraint equations, which are expressed by general coordinates of two connected parts, may be derived by relating two joint reference frames that are attached to the connected parts, respectively. For example, a revolution joint contains five equations to constrain three translation degrees of freedom (OᵢOⱼ=0) and two rotation degrees of freedom (eₓⱼ⊥e_{zi}& e_{yj}⊥e_{zi}). A prismatic joint contains five equations to constrain three rotation degrees of freedom (eₓⱼ⊥e_{zi}& e_{yj}⊥e_{zi}& eₓᵢ⊥e_{yj}) and two translation degrees of freedom (eₓᵢ⊥OᵢOⱼ& e_{yi}⊥OᵢOⱼ). Although types of joints may be different, constraint equations are similar. Therefore, a set of nonlinear joint constraint equations expressed by general coordinates of related parts maybe easily obtained and so are their Jacobian components.

In general, there are two types of driver constraint equations. One is for rotation driver (∠ (eₓᵢ, eₓⱼ) and the other is for translation driver (OᵢOⱼ·e_{zi}). Similarly, they can be easily derived by relating two joint reference frames that are attached to each connected part respectively. By using the Euler parameters approach, the following may be achieved:

1. Number of independent variables (general coordinates) and constraint equations depends only on the number of joint constraints, drivers, and parts involved. The independent variables are independent of the number of loops existed in the assembly and how joints located in a loop as in the vector loop approach. Therefore, the Euler parameters approach may be applied for any generic mechanisms.

2. Flexibility (i.e., the reverse of stiffness) of a piece part maybe taken into account by introducing Euler parameters. The more flexible the piece part, the larger an offset value is between the constraint, e₁²+e₂²+e₃²+e₄² and 1. It is impossible to consider flexibility of a piece part in the vector loop approach.

3. The ways that joint constraint equations are set up allow a user to control joint mismatch or axis misalignment. This feature is used when integrating kinematics analysis with dimension tolerance variation simulation. It is impossible to implement this feature in the vector loop approach.

It should be understood that upon adopting the Euler parameters approach, a user may perform the following modifications to the process of FIG. 3 to take into account special cases to improve robustness of the system.

1. Use an inverse calculation of the Euler parameters from a given transformation matrix to take into account the possibility of a special singular case.

2. Take into consideration the relationship between a local transformation matrix and a global transformation matrix for a piece part into considerations so that more generic assembled sequences may be applied.

3. Consider equivalent angular solutions during iterations.

4. Modify the Gaussian elimination and backward substitution with total pivoting to take into account a case that may have multiple solutions.

5. Allow a user to have control over the piece part flexibility and the constraint tolerances.

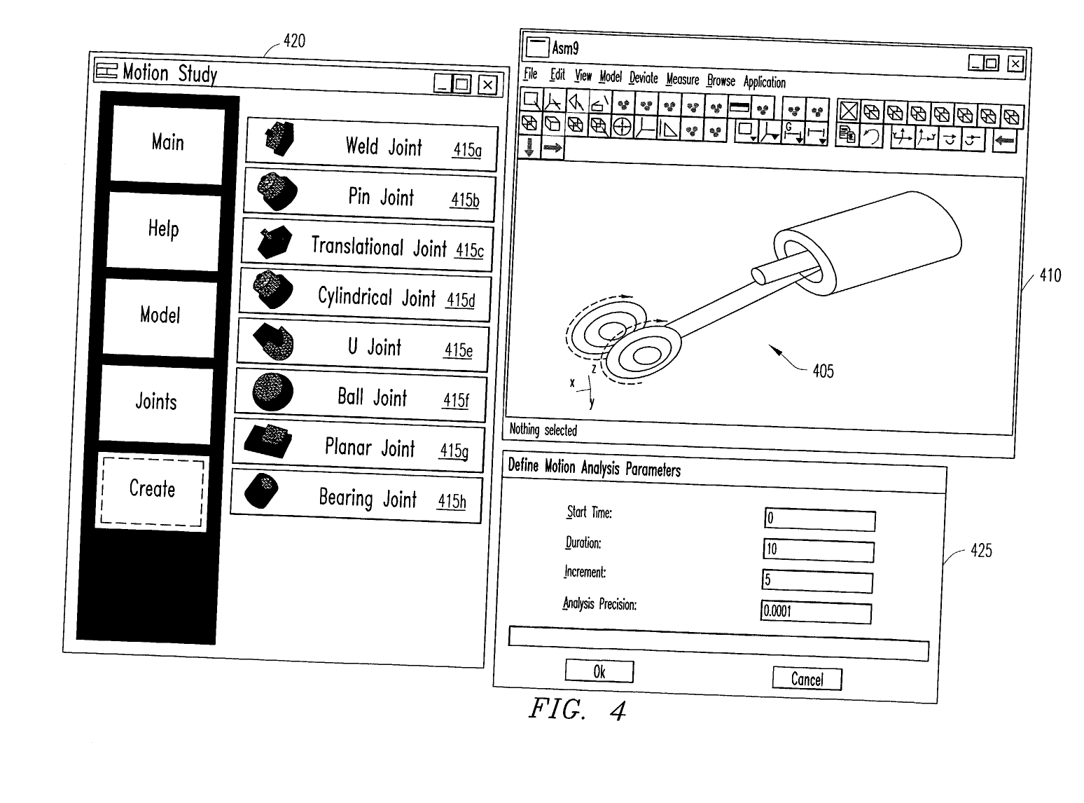

FIG. 4 is an exemplary graphical user interface (GUI) 400 for defining, displaying, and simulating a multi-dimensional kinematic model 405 according to FIG. 3. The kinematic model 405, which may be imported from a CAD system, is shown in window 410. Elements 415a-415h in window 420 may be utilized to define joint types for placing reference frames on the joints connecting the piece parts of the kinematic model 405. Window 425 provides for setting and adjusting parameters for controlling the simulation. As shown, the parameters may include: (i) start time, (ii) duration, (iii) increment, and (iv) analysis precision. Other parameters may also be included. In operation, the design engineer may execute the simulation and view and/or obtain data resulting from dynamically moving the kinematic model 405 while simultaneously performing tolerance variations.

The previous description is of a preferred embodiment for implementing the invention, and the scope of the invention should not necessarily be limited by this description. The scope of the present invention is instead defined by the following claims.

What is claimed is:

1. A system for providing graphical and analytical dynamic modeling of a multi-dimensional mechanical mechanism, said system comprising:
at least one processor for computing a dynamic simulation of movement of the multi-dimensional mechanical mechanism, and rendering the multi-dimensional mechanical mechanism, the dynamic simulation simultaneously performing kinematic and tolerance modeling; and
a display for displaying the rendered multi-dimensional mechanical mechanism during the dynamic simulation.
